(19) United States
(12) Patent Application Publication
(10) Pub. No.: US 2013/0073630 A1
(43) Pub. Date: Mar. 21, 2013

(54) Device, System And Method For Changing Multi-User Relationship Chain

(71) Applicant: Tencent Technology (Shenzhen) Company Limted, Shenzhen City (CN)

(72) Inventor: Li ZHANG, Shenzhen City (CN)

(73) Assignee: TENCENT TECHNOLOGY (SHENZHEN) COMPANY LIMITED, Shenzhen City (CN)

(21) Appl. No.: 13/675,617

(22) Filed: Nov. 13, 2012

Related U.S. Application Data
(63) Continuation of application No. PCT/CN2011/077711, filed on Jul. 28, 2011.

(30) Foreign Application Priority Data
Aug. 31, 2010 (CN) 201010271778.8

(51) Int. Cl. H04L 12/58

(52) U.S. Cl. CPC H04L 51/32
USPC 709/204

(57) ABSTRACT

A push information managing module configured to receive a listening notification signaling, obtain a UIN of a new listener contained in the listening notification signaling, and send the UIN of the new listener to a relationship chain managing module. The relationship chain managing module receives the UIN of the new listener, adds the UIN of the new listener into a listener list, and notifies the relationship chain prompting module that the new listener listens to the user. A relationship chain prompting module receives the notification from the relationship chain managing module, and after determining that the notification indicates that the relationship chain changes, creates an indication identification to prompt the user that the new listener listens to the user.

### CROSS-REFERENCE TO RELATED APPLICATIONS

This application is a continuation of International Application No. PCT/CN2011/077711, filed on Jul. 28, 2011. This application claims the benefit and priority of Chinese Patent Application No. 201010271778.8, filed on Aug. 31, 2010. The entire disclosures of each of the above applications are incorporated herein by reference.

### FIELD

The present disclosure relates to computer technologies and to a device, system and method for changing a multi-user relationship chain.

### BACKGROUND

This section provides background information related to the present disclosure which is not necessarily prior art.

Instant Messenger (IM) has become a necessary communication tool in the daily life of most network users, and is widely applied to both entertainment and business uses. The IM provides a network identification (i.e., an identification number) for each user, so as to differentiate the user from other users. The user may chat with one buddy through the IM, or chat with multiple buddies through establishing a one-to-N group. The interaction performed between the user and buddies through the IM adopts a conversation mode, and thus the user may fluently communicate with the buddies. However, the efficiency of this conversation mode is very low, and an entire thought is usually unable to be obtained unless multiple transmissions are performed.

With the development of Internet, Blog is widely applied as a new Internet conversation mode. Blog is a mode of publishing and posting articles by a Blogger on Internet through specific software, and thus is a mode of expressing ideas by the Blogger. The Blogger can express a full idea through Blog, the Blog is not for a specific object, and thus any user on Internet can browse the articles of the Blogger and leave word.

Micro-blog is a new network conversation mode widely applied in recent years. Micro-blog is also called Blog of a word, and is a network conversation mode through which a user expresses an idea with a word. Compared with the IM and Blog, the efficiency of transferring information through micro-blog is higher. Micro-blog is also not for a specific object, and thus is a one-to-one or one-to-N message chat mode, which means that a user may transfer messages to infinite users through micro-blog, and may receive messages transferred by infinite users through micro-blog.

However, the number of buddies which can be added by the user through the IM is limited, the user and buddies need to be validated with each other to establish a relationship, so the relationship chain is simple. In Blog, users may browse articles of the Blogger and leave word without validation. However, the Blogger can only learn which users follow the Blogger's articles and leave word for the articles, but can not follow these users. That is to say, the Blogger can not directly browse articles published by these users, but must obtain Blog websites of these users first, and then browse the articles of these users after entering the Blog spaces of these users. As can be seen, the relationship chain between users in Blog is also simple.

In a micro-blog application, a listening relationship may be established without validation between users. Moreover, in theory one user may face infinite users, and thus a broad relationship chain is needed. Through the relationship chain, a user may learn, during a micro-blog using procedure, how many users and which users listen to the user, and may listen to these users randomly. However, IM's validation notifying mechanism for establishing a buddy relationship is inapplicable to the loose coupling relationship chain such as micro-blog. The relationship chain providing mechanism in Blog is too simple, and thus it is needed to provide a mechanism for effectively changing a user relationship chain, so as to guarantee that the user can learn, during the micro-blog using procedure, how many users and how many new users listen to the user, and guarantee that the user can rapidly view which users and which new users listen to the user, and further determine whether to listen to these users according to a viewing result.

### SUMMARY

This section provides a general summary of the disclosure, and is not a comprehensive disclosure of its full scope or all of its features.

Various embodiments provide a device, system and method for changing a multi-user relationship chain, so as to guarantee that a user can learn, during a micro-blog using procedure, how many users and how many new users listen to the user, and guarantee that the user can rapidly view which users and which new users listen to the user, and further determine whether to listen to these users according to a viewing result.

A device for changing a multi-user relationship chain includes a push information managing module, a relationship chain managing module and a relationship chain prompting module, where

the push information managing module is configured to receive a listening notification signaling, obtain a Unique Identification Number (UIN) of a new listener contained in the listening notification signaling, and send the UIN of the new listener to the relationship chain managing module;

the relationship chain managing module is configured to receive the UIN of the new listener sent by the push information managing module, add the UIN of the new listener into a listener list, and notify the relationship chain prompting module that the new listener listens to the user; and

the relationship chain prompting module is configured to receive the notification from the relationship chain managing module, and after determining that the notification indicates that the relationship chain changes, create an indication identification to prompt the user that the new listener listens to the user.

A system for changing a multi-user relationship chain includes a client device and a micro-blog relationship chain server; where

the micro-blog relationship chain server is configured to send a listening notification signaling to the client device, wherein the listening notification signaling contains a Unique Identification Number (UIN) of a new listener; and

the client device is configured to obtain the UIN of the new listener contained in the listening notification signaling, add the UIN of the new listener into a listener list, and create an indication identification to prompt the user that the new listener listens to the user.

A method for changing a multi-user relationship chain includes:

receiving, by a client device, a listening notification signaling, wherein the listening notification signaling contains a Unique Identification Number (UIN) of a new listener; and

obtaining, by the client device, the UIN of the new listener contained in the listening notification signaling, adding the UIN of the new listener into a listener list, and creating an indication identification to prompt the user that the new listener listens to the user.

As can be seen from the above technical solution, according to the device, system and method for changing the multi-user relationship chain, the user may receive, during a micro-blog using procedure, the notification indicating that the relationship chain changes, and view the up to date change of the relationship chain, so as to conveniently view how many listeners and how many new listeners listen to the user, and view which listeners and which new listeners listen to the user.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic diagram illustrating a system for changing a multi-user relationship chain according to an embodiment;

FIG. 2 is a schematic diagram illustrating a device for changing a multi-user relationship chain according to an embodiment;

FIG. 3 is a schematic diagram illustrating a device for changing a multi-user relationship chain according to another embodiment;

FIG. 4 is a schematic diagram illustrating a prompting interface of newly added listener according to an embodiment;

FIG. 5 is a schematic diagram illustrating a prompting interface of newly added listener according to another embodiment;

FIG. 6 is a flowchart illustrating a method for changing a multi-user relationship chain according to an embodiment; and

FIG. 7 is a flowchart illustrating a method for changing a multi-user relationship chain according to another embodiment.

Corresponding reference numerals indicate corresponding parts throughout the several views of the drawings.

### DETAILED DESCRIPTION

In order to make the object, technical solution and merits of the present invention clearer, various embodiments will be illustrated in detail hereinafter with reference to the accompanying drawings. Obviously, the described embodiments are only partial embodiments of the present invention, but are not all embodiments. Various embodiments may be represented as different forms, and thus is not limited to the described embodiments. According to various embodiments, one skilled in the art can obtain other embodiments without creative labor, which belong to the protection scope of the present invention.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

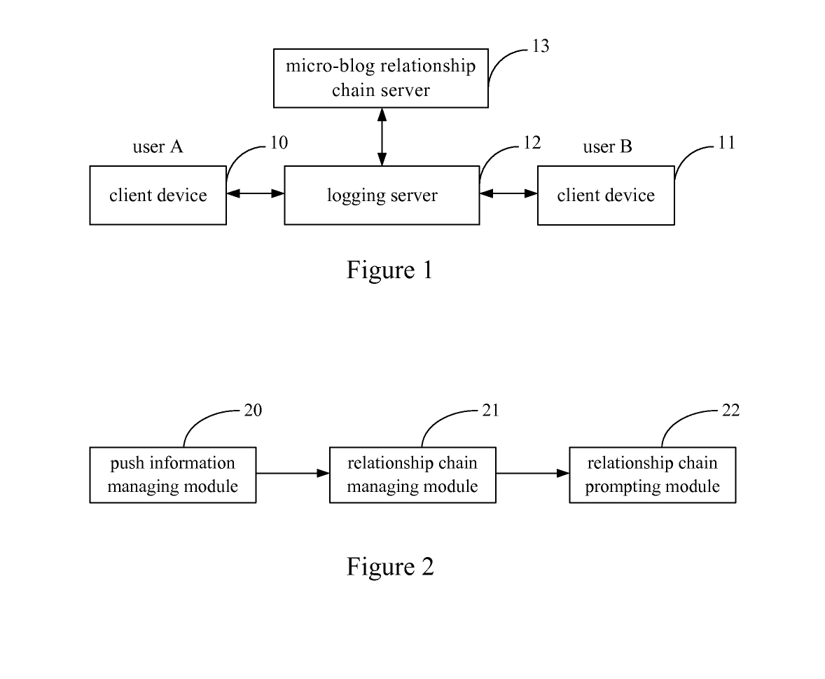

FIG. 1 is a schematic diagram illustrating a system for changing a multi-user relationship chain according to an embodiment. As shown in FIG. 1, the system includes: a client device 10 of user A, a client device 11 of user B, a logging server 12 and a micro-blog relationship chain server 13.

The user A sends an identification number and password of the user A to the logging server 12 through the client device 10. After the user A passes verification, a network connection channel is established between the client device 10 and the logging server 12, and the client device 10 sends a heartbeat packet to the logging server 12 periodically to ensure the connection between the client device 10 and the logging server 12. After the user A logs on the logging server 12 through the client device 10, the client device 10 creates a micro-blog panel managing module, and the user A may publish micro-blog or listen to micro-blog of other users through the created micro-blog panel managing module.

Similarly, the user B sends an identification number and password of the user B to the logging server 12 through the client device 11. After the user B passes verification, a network connection channel is established between the client device 11 and the logging server 12, and the client device 11 sends a heartbeat packet to the logging server 12 periodically to ensure the connection between the client device 11 and the logging server 12. After the user B logs on the logging server 12 through the client device 11, the client device 11 creates a micro-blog panel managing module, and the user B may publish micro-blog or listen to micro-blog of other users through the created micro-blog panel managing module.

In this embodiment, when the user B intends to listen to the user A after logging on the logging server 12 through the client device 11, the user B sends a listening request signaling to the logging server 12 through the client device 11, where the listening request signaling includes a listener, i.e., a Unique Identification Number (UIN) of the user B, a user to be listened, i.e., a UIN of the user A and a signaling command number for indicating the signaling type. After receiving the listening request signaling, the logging server 12 determines, according to the signaling command number, that the listening request signaling is a signaling of micro-blog type, and forwards the listening request signaling to the micro-blog relationship chain server 13. After receiving the listening request signaling, the micro-blog relationship chain server 13 obtains UINs of the user A and user B from the listening request signaling, sets a listening relationship between the user A and the user B, i.e., adds the user B into a listener list of the user A, and stores the listener list.

In this embodiment, since it is possible that a listener listens to the user A when the user A is not online, the micro-blog relationship chain server 13 updates the stored listener list in real time. Every time the user A logs on the logging server 12 through the client device 10, the user A first obtains the listener list stored by the micro-blog relationship chain server 13, so as to ensure that the listener list displayed to the user A is up to date. After the user A obtains the listener list, if a new listener listens to the user A, the micro-blog relationship chain server 13 modifies the stored listener list, and issues, according to the IP address and port number of client device 10 of user A, a listening notification signaling to the client device 10 of the user A through the logging server 12. The UIN of the new listener is carried in the listening notification signaling and issued to the client device 10. After receiving the listening notification signaling, the client device 10 of the user A obtains the UIN of the new listener, modifies the obtained listener list, adds the UIN of the new listener into the listener list, labels the UIN of the new listener with a new listener identification “New”, and displays the listener list to the user A on demand. Further, the number of listeners listening to the user A and the number of new listeners listening to the user A may be labeled in the listener list. In this way, the user A may learn, through viewing the listener list, that how many listeners listen to the user A and which listeners are new listeners, and may determine whether to select a certain listener to listen to the micro-blog of the listener.

FIG. 1 only shows two users, and the two users use the same logging server together. But, one skilled in the art would recognize that, there may be multiple users in other embodiments and the multiple users may log on different logging servers.

In the embodiment, the user may receive, during a micro-blog using procedure, the notification indicating that the relationship chain changes, views the up to date change of the relationship chain through the listener list, so as to conveniently view how many listeners listen to the user and how many new listeners listen to the user, and views which listeners and which new listeners listen to the user. Further, if the user intends to obtain detailed information about a certain listener, the user may trigger a function control corresponding to the listener. In this way, the client device may obtain the identification information and individual materials of the listener from the logging server, and displays the identification information and individual materials of the listener to the user.

FIG. 2 is a schematic diagram illustrating a device for changing a multi-user relationship chain according to an embodiment. As shown in FIG. 2, the device includes a push information managing module 20, a relationship chain managing module 21 and a relationship chain prompting module 22.

The push information managing module 20 is configured to receive a listening notification signaling pushed by a micro-blog relationship chain server, obtain an UIN of a new listener contained in the listening notification signaling, and send the UIN of the new listener to the relationship chain managing module 21.

The relationship chain managing module 21 is configured to receive the UIN of the new listener sent by the push information managing module 20, add the UIN of the new listener into a listener list, and notify the relationship chain prompting module 22 that the new listener listens to the user.

The relationship chain prompting module 22 is configured to receive the notification from the relationship chain managing module 21, and after determining that the notification indicates that the relationship chain changes, and create an indication identification on a micro-blog panel managing module of the client device to prompt the user that the new listener listens to the user.

In this embodiment, the device may be configured on an IM client device, or may be configured separately. As shown in FIG. 1, the device may be configured on the client device of the user A and the client device of the user B; or, the device is configured separately and connected with the client devices shown in FIG. 1 and the micro-blog relationship chain server respectively. That is to say, the device is connected with the micro-blog relationship chain server and the client device of the user A respectively, and is connected with the micro-blog relationship chain server and the client device of the user B.

FIG. 3 is a schematic diagram illustrating a device for changing a multi-user relationship chain according to another embodiment. The device may be divided into three layers based on a logic structure, which include a data obtaining and managing layer, a logic managing layer and an application managing layer. The data obtaining and managing layer is configured to manage identification information and individual materials of user, a listener list and data pushed by the micro-blog relationship chain server. Further, if the device is configured separately, the identification information of the user includes a nickname, a sign bit and so on. If the device is configured on the IM client device and the identification number of the IM client device is different from the UIN of the user, and the identification information of the user may further include the identification number of the IM client device. If the identification number of the IM client device is the same as the UIN of the user, the identification information of the user may not include the identification number of the IM client device. The individual materials of the user include sex and age of the user. The logic managing layer is configured to process various original data provided by the data obtaining and managing layer, for example, bundle the UINs in the listener list with the identification information and individual materials of each listener respectively, so as to obtain the whole information of each listener and provide the whole information to the application managing layer. The application managing layer is configured to display the listener list and related information of listeners to the user, create and manage various function controls for performing operations by the user, e.g., a relationship chain change prompting control, a listener list displaying control and so on.

Specifically, the device for changing a multi-user relationship chain shown in FIG. 3 includes the push information managing module 20, the relationship chain managing module 21 and the relationship chain prompting module 22 shown in FIG. 2, and further includes a listener list managing module 23, a logic managing module 24, an identification number managing module 25 and a material managing module 26.

The push information managing module 20, the relationship chain managing module 21, the identification number managing module 25 and the material managing module 26 belong to the data obtaining and managing layer, the relationship chain prompting module 22 and the listener list managing module 23 belong to the logic managing layer, and the logic managing module 24 belongs to the application managing layer.

One skilled in the art would recognize that the device shown in FIG. 3 is only an example, and cannot be used to limit the scope of protection. There may be various modification, equivalent substitution and improvement of the device. For example, some modules may be extended and/or integrated, and other modules may be added into the device. The functions of all modules of the device will be illustrated in detail hereinafter.

The push information managing module 20 is configured to receive a listening notification signaling pushed by the micro-blog relationship chain server, obtain an UIN of a new listener contained in the listening notification signaling, and send the UIN of the new listener to the relationship chain managing module 21. After the device obtains the listener list from the micro-blog relationship chain server, if a new listener listens to the user using the device, the micro-blog relationship chain server automatically sends the listening notification signaling containing the UIN of the new listener to the push information managing module 20, and then the push information managing module 20 obtains the UIN of the new listener and sends the UIN of the new listener to the relationship chain managing module 21.

The relationship chain managing module 21 is configured to obtain the listener list stored by the micro-blog relationship chain server after the user logs on the logging server, receive the UIN of the new listener sent by the push information managing module 20, add the UIN of the new listener into the listener list, label the UIN of the new listener with a new listener identification “New”, notify, through an event notification mode, the relationship chain prompting module 22 that the new listener listens to the user, and provide the listener list to the listener list managing module 23 on demand. The relationship chain managing module 21 is further configured to record in the listener list that how many listeners listen to the user and how many new listeners listen to the user.

The relationship chain prompting module 22 is configured to receive the notification from the relationship chain managing module 21, and after determining that the notification indicates that the relationship chain changes, and create an indication identification on the micro-blog panel managing module to prompt the user, for instance, create a general yellow strip to prompt the user. The relationship chain prompting module 22 is further configured to monitor a triggering message of the user, for instance, a mouse clicking message, and if it is confirmed that the user intends to view a new listener, notify the listener list managing module 23 to display the listener list to the user.

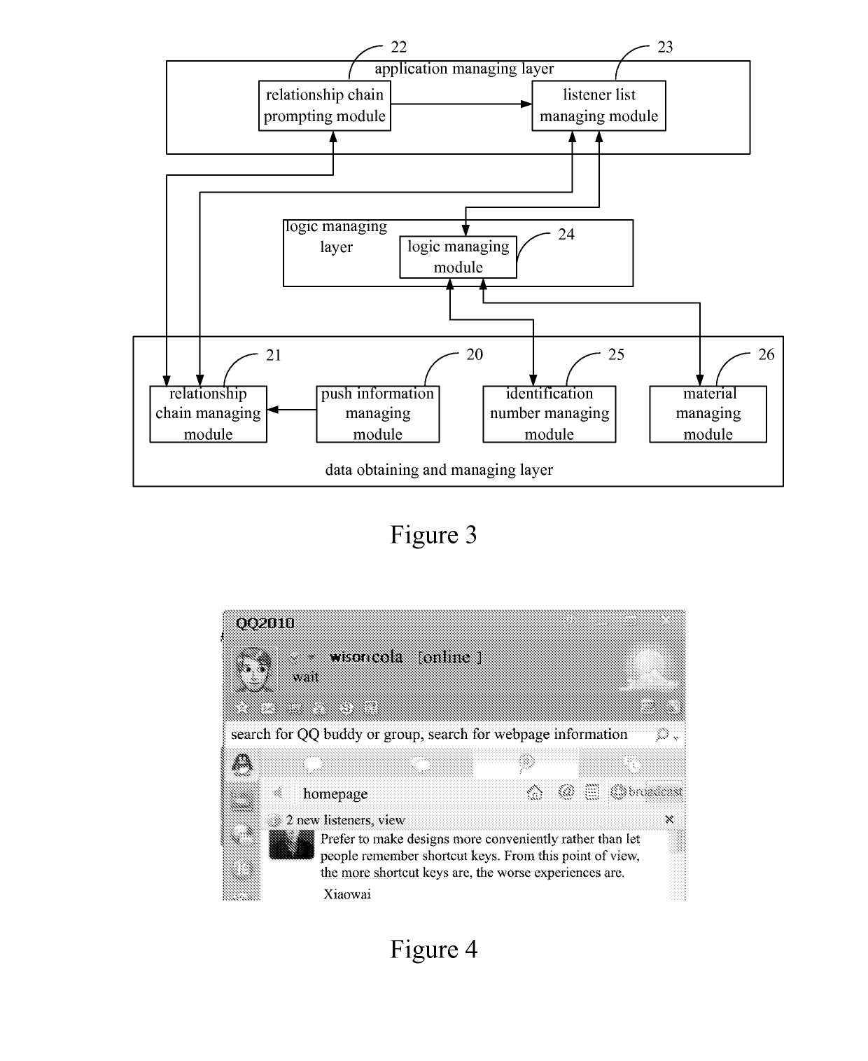

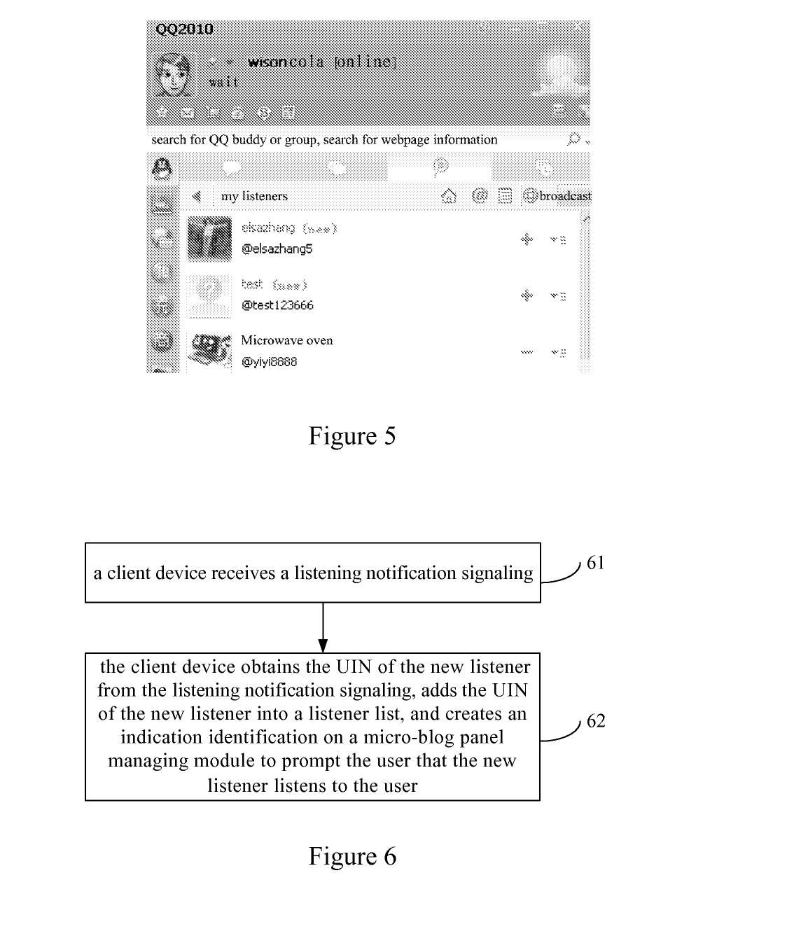

The listener list managing module 23 is configured to, after receiving the notification from the relationship chain prompting module 22, obtain the listener list from the relationship chain managing module 21, and display the listener list to the user. In this embodiment, if there is only one listener in the listener list, the listener list managing module 23 displays the UIN and recently published micro-blog of the listener to the user. As shown in FIG. 4, if there are multiple listeners in the listener list, the listener list managing module 23 displays the UINs of the multiple listeners to the user according to an order that the multiple listeners listen to the user, where new listeners are labeled with a new listener identification “New”, as shown in FIG. 5. In this embodiment, the listener list managing module 23 is further configured to, when the user wants to learn the detailed information of a certain listener and triggers a function control corresponding to the listener, send the UIN of the listener to the logic managing module 24, and obtain the identification information and individual materials of the listener through the logic managing module 24, and display the identification information and individual materials of the listener to the user.

In this embodiment, if the user intends to listen to the micro-blog of a certain listener, the user may locate a guest page corresponding to the listener through triggering a page control corresponding to the listener. The guest page refers to the micro-blog space of the listener. Since the listener is a guest of the user, the micro-blog space of the listener is called the guest page of the user. In the guest page, the user may view all micro-blogs published by the listener, all comments published by other users for these micro-blogs, users listened by the listener and users which have listened to the listener, and may publish comments for the micro-blogs of the listener.

The logic managing module 24 is configured to send an obtaining instruction to the identification number managing module 25 and the material managing module 26 according to the UIN of the listener sent by the listener list managing module 23, obtain the identification information and individual material of the listener, process the various original data of the listener, for instance, bundle the UIN of the listener with the identification information and individual material of the listener so as to obtain the whole information of the listener, and provide the whole information of the listener to the listener list managing module 23.

The identification number managing module 25 is configured to obtain the identification information of the listener from the logging server after receiving an obtaining instruction of the logic managing module 24, and send the obtained identification information to the logic managing module 24.

The material managing module 26 is configured to obtain the individual materials of the listener from the logging server after receiving an obtaining instruction of the logic managing module 24, and send the obtained individual materials to the logic managing module 24.

The device for changing a multi-user relationship chain described by this embodiment may be configured on an IM client device, and may also be configured separately.

FIG. 6 is a flowchart illustrating a method for changing a multi-user relationship chain according to an embodiment. As shown in FIG. 6, the method includes following processes.

Block 61, a client device receives a listening notification signaling, where the listening notification signaling contains a UIN of a new listener.

Block 602, the client device obtains the UIN of the new listener from the listening notification signaling, adds the UIN of the new listener into a listener list, and creates an indication identification on a micro-blog panel managing module to prompt the user that the new listener listens to the user.

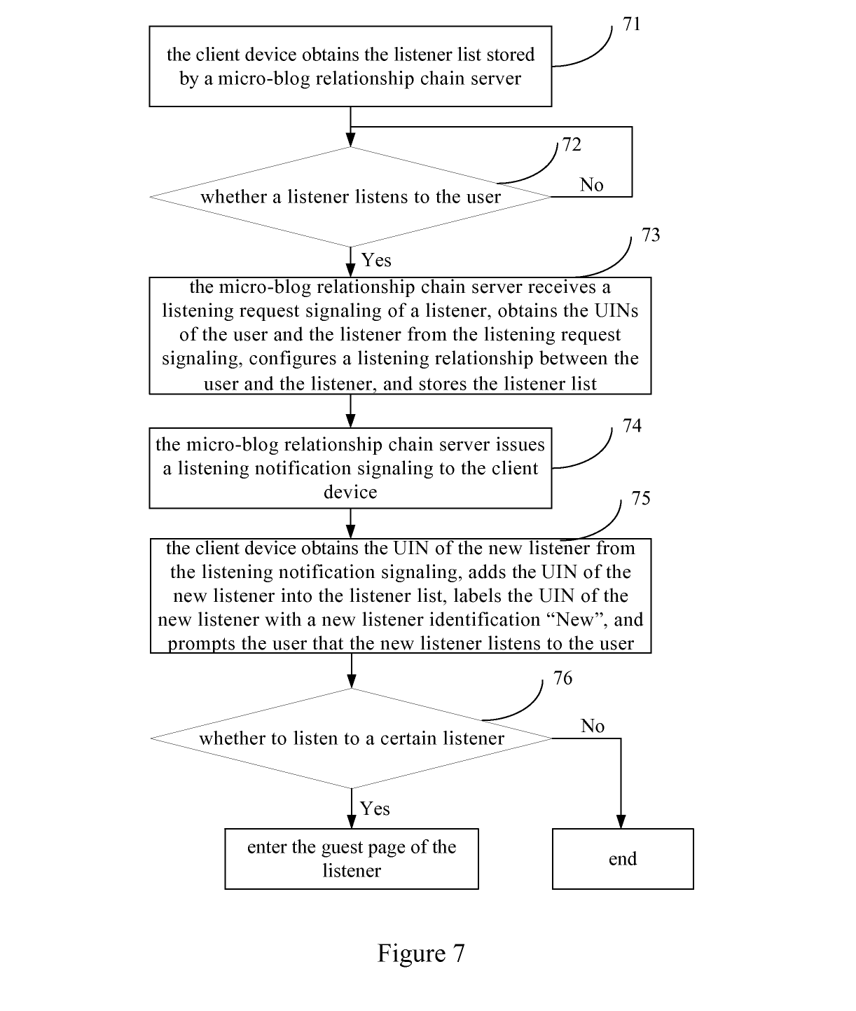

FIG. 7 is a flowchart illustrating a method for changing a multi-user relationship chain according to another embodiment.

Block 71, after the user logs on a logging server through the client device, the client device obtains the listener list stored by a micro-blog relationship chain server.

Since it is possible that a listener listens to the micro-blog of the user when the user is not online, the micro-blog relationship chain server updates the stored listener list in real time. In this way, every time the user logs on the logging server, the client device first obtain the listener list stored by the micro-blog relationship chain server, so as to ensure that the listener list displayed to the user is up to date.

Block 72, the micro-blog relationship chain server determines whether a listener listens to the user. If yes, block 73 is performed. Otherwise, block 72 is performed again.

Block 73, the micro-blog relationship chain server receives a listening request signaling of a listener, obtains the UINs of the user and the listener from the listening request signaling, configures a listening relationship between the user and the listener, i.e., adds the listener into the listener list of the user, and stores the listener list.

Block 74, the micro-blog relationship chain server issues a listening notification signaling to the client device, where the listening notification signaling contains the UIN of the new listener.

Block 75, after receiving the listening notification signaling, the client device obtains the UIN of the new listener from the listening notification signaling, adds the UIN of the new listener into the listener list, labels the UIN of the new listener with a new listener identification “New”, and prompts the user that the new listener listens to the user. In this process, the client device may record in the listener list that how many listeners listen to the user and how many new listeners listen to the user.

Block 76, through the client device, the user determines whether to listen to a certain listener. If yes, the user enters the guest page of the listener. Otherwise, the procedure terminates.

As can be seen from the above embodiments, according to the device, system and method for changing the multi-user relationship chain, the user may receive, during a micro-blog using procedure, the notification indicating that the relationship chain changes, and view the up to date change of the relationship chain, so as to conveniently view that how many listeners and how many new listeners listen to the user, and view that which listeners and which new listeners listen to the user. Further, if the user intends to obtain the detailed information of a certain listener, the user may trigger a function control corresponding to the listener. In this way, the client device may obtain the identification information and individual materials of the listener and display the identification information and individual materials of the listener to the user.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A device for changing a multi-user relationship chain, comprising: a push information managing module, a relationship chain managing module and a relationship chain prompting module, wherein
the push information managing module is configured to receive a listening notification signaling, obtain a Unique Identification Number (UIN) of a new listener contained in the listening notification signaling, and send the UIN of the new listener to the relationship chain managing module;
the relationship chain managing module is configured to receive the UIN of the new listener sent by the push information managing module, add the UIN of the new listener into a listener list, and notify the relationship chain prompting module that the new listener listens to the user; and
the relationship chain prompting module is configured to receive the notification from the relationship chain managing module, and after determining that the notification indicates that the relationship chain changes, create an indication identification to prompt the user that the new listener listens to the user.

2. The device of claim 1, wherein the relationship chain managing module is further configured to obtain the listener list stored by a micro-blog relationship chain server after the user logs on a logging server.

3. The device of claim 1, further comprising a listener list managing module; wherein
the relationship chain prompting module is further configured to monitor a triggering message of the user, if it is confirmed that the user intends to view the new listener, notify the listener list managing module; and
the listener list managing module is configured to, after receiving the notification from the relationship chain prompting module, obtain the listener list from the relationship chain managing module, and display the listener list to the user.

4. The device of claim 3, further comprising a logic managing module; wherein
the listener list managing module is further configured to, when the user intends to learn the detailed information of a listener and triggers a function control corresponding to the listener, send the UIN of the listener to the logic managing module, and receive the whole information of the listener from the logic managing module, and display the whole information of the listener to the user; and
the logic managing module is configured to obtain the identification information and individual material of the listener according to the UIN of the listener sent by the listener list managing module, bundle the UIN of the listener with the identification information and individual material of the listener, obtain the whole information of the listener and provide the whole information of the listener to the listener list managing module.

5. The device of claim 4, further comprising an identification number managing module and a material managing module; wherein
the identification number managing module is configured to obtain the identification information of the listener from the logging server after receiving an obtaining instruction of the logic managing module, and send the obtained identification information to the logic managing module; and
the material managing module is configured to obtain the individual materials of the listener from the logging server after receiving an obtaining instruction of the logic managing module, and send the obtained individual materials to the logic managing module.

6. The device of claim 3, wherein the listener list managing module is configured to, when there is one listener in the listener list, display the UIN and recently published micro-blog of the listener to the user; if there are multiple listeners in the listener list, display the UINs of the multiple listeners to the user according to an order that the multiple listeners listen to the user, wherein new listeners are labeled with a new listener identification.

7. The device of claim 1, further comprising a page control corresponding to a listener, configured to, when the user intends to listen to the listener, locate the guest page of the listener for the user.

8. A system for changing a multi-user relationship chain, comprising a client device and a micro-blog relationship chain server; wherein
the micro-blog relationship chain server is configured to send a listening notification signaling to the client device, wherein the listening notification signaling contains a Unique Identification Number (UIN) of a new listener; and
the client device is configured to obtain the UIN of the new listener contained in the listening notification signaling, add the UIN of the new listener into a listener list, and create an indication identification to prompt the user that the new listener listens to the user.

9. The system of claim 8, wherein the client device is further configured to monitor a triggering message of the user, and if it is confirmed that the user intends to view the new listener, display the listener list to the user.

10. The system of claim 9, wherein the client device is further configured to, when the user intends to learn detailed information of a listener and triggers a function control corresponding to the listener, obtain the identification information and individual material of the listener according to the UIN of the listener, bundle the UIN of the listener with the identification information and individual material of the listener, obtain whole information of the listener and display the whole information of the listener to the user.

11. The system of claim 9, wherein the client device is further configured to, when there is one listener in the listener list, display the UIN and recently published micro-blog of the listener to the user; if there are multiple listeners in the listener list, display the UINs of the multiple listeners to the user according to an order that the multiple listeners listen to the user, wherein new listeners are labeled with a new listener identification.

12. The system of claim 8, wherein the client device is further configured to, when the user intends to listen to a listener, locate the guest page of the listener for the user.

13. The system of claim 8, wherein the micro-blog relationship chain server is further configured to receive a listening request signaling of a listener, obtain the UINs of the listener and the user, add the listener into the listener list of the user, and store the listener list.

14. A method for changing a multi-user relationship chain, comprising:
receiving, by a client device, a listening notification signaling, wherein the listening notification signaling contains a Unique Identification Number (UIN) of a new listener; and
obtaining, by the client device, the UIN of the new listener contained in the listening notification signaling, adding the UIN of the new listener into a listener list, and creating an indication identification to prompt the user that the new listener listens to the user.

15. The method of claim 14, further comprising:
monitoring, by the client device, a triggering message of the user, and if it is confirmed that the user intends to view the new listener, displaying the listener list to the user.

16. The method of claim 15, further comprising:
when the user intends to learn detailed information of a listener and triggers a function control corresponding to the listener, obtaining, by the client device, the identification information and individual material of the listener according to the UIN of the listener, bundling the UIN of the listener with the identification information and individual material of the listener, obtaining whole information of the listener and displaying the whole information of the listener to the user.

17. The method of claim 15, further comprising:
when there is one listener in the listener list, displaying, by the client device, the UIN and recently published micro-blog of the listener to the user; if there are multiple listeners in the listener list, displaying the UINs of the multiple listeners to the user according to an order that the multiple listeners listen to the user, wherein new listeners are labeled with a new listener identification.

18. The method of claim 14, further comprising:
when the user intends to listen to a listener, locating the guest page of the listener for the user.

19. The method of claim 14, further comprising:
receiving, by the micro-blog relationship chain server, a listening request signaling of a listener, obtaining the UINs of the listener and the user, adding the listener into the listener list of the user, and storing the listener list.
